(19) United States
(12) Patent Application Publication
(10) Pub. No.: US 2026/0346620 A1
(43) Pub. Date: Nov. 5, 2026

(54) RECORDING APPARATUS, RECORDING METHOD, AND NON-TRANSITORY COMPUTER READABLE STORAGE MEDIUM

(71) Applicant: CANON KABUSHIKI KAISHA, Tokyo (JP)

(72) Inventors: AKIRA YAMAMOTO, Kanagawa (JP); TETSUYA EDAMURA, Tokyo (JP); YUTARO NAKATSUKA, Kanagawa (JP); YOHEI KOHASHI, Kanagawa (JP); KAZUKI NARUMI, Tokyo (JP); TATSUAKI ORIHARA, Tokyo (JP); TORU OHNISHI, Kanagawa (JP)

(21) Appl. No.: 19/656,099

(22) Filed: Apr. 23, 2026

(30) Foreign Application Priority Data
May 2, 2025 (JP) 2025-076892

(51) Int. Cl. B41J 11/00; B41J 2/045; B41J 2/21

(52) U.S. Cl. CPC B41J 11/0015; B41J 2/04553; B41J 2/04558; B41J 2/04566; B41J 2/2114; B41J 11/009; B41J 2/04586

(57) ABSTRACT

In a recording apparatus, the type of recording medium is determined based on recording medium information that is input, and if it is determined that the recording medium is a low-permeability medium, the temperature of the recording medium obtained by measurement by a measurement unit is acquired. The recording apparatus selects a reaction liquid ejection amount table according to a combination of the type of recording medium and the acquired recording medium temperature. In the recording apparatus, a plurality of reaction liquid ejection amount tables is stored so that the application amount of reaction liquid can be changed according to a combination of the type of recording medium and the recording medium temperature. The recording apparatus applies the selected reaction liquid ejection amount table to a reaction liquid ejection signal, and performs quantization processing on the reaction liquid ejection signal and ink ejection signals.

### BACKGROUND

### Field of the Technology

The present invention relates to a recording technique for performing recording on a recording medium using a reaction liquid and ink.

### Description of the Related Art

Conventionally, inkjet recording apparatuses that form an image on a recording medium by ejecting aqueous ink containing a color material from a recording element are known as a method for forming an image on a recording medium. In some of these recording apparatuses a recording method is employed in which a reaction liquid containing a component that increases the viscosity of the ink is ejected together with the ink, and the color material is fixed to the recording medium by a chemical reaction caused when the reaction liquid and the ink come in contact with each other on the recording medium. When the ink lands on the recording medium, if the amount of reaction liquid remaining on the recording medium surface is insufficient, the aggregation property of the ink will decrease and there is a possibility that the amount of ink fixed to the recording medium will be insufficient, which may cause a reduction in color density or image unevenness or the like, leading to a decrease in image quality. Conversely, if the amount of reaction liquid is excessive, image unevenness may occur due to cracking of the ink film or ink being embedded in the reaction liquid film or the like. Japanese Patent Laid-Open No. 2002-321349 discloses a technique of ensuring that the amount of treatment liquid is neither excessive nor insufficient relative to the ink that is used by varying the ejection amount of a treatment liquid, which is a reaction liquid, according to the type of ink.

### SUMMARY

The present disclosure comprises a recording unit configured to apply ink and a reaction liquid that reacts with the ink onto a recording medium to record an image, a measurement unit configured to measure a recording environment condition during recording by the recording unit, and a control unit configured to control an application amount of the reaction liquid from the recording unit based on a measurement result obtained by the measurement unit.

Features of the present disclosure will become apparent from the following description of embodiments with reference to the attached drawings.

### BRIEF DESCRIPTION OF THE DRAWINGS

FIG. 1 is a schematic view illustrating a configuration of a recording apparatus in one embodiment;

FIG. 2 is a block diagram illustrating an example of the configuration of a system in one embodiment;

FIG. 3 is a flowchart illustrating an example of image processing in a first embodiment;

FIG. 4 is a diagram illustrating an example of a reaction liquid ejection amount table that determines a reaction liquid ejection signal which indicates an ejection amount of a reaction liquid based on an ink ejection signal of each color component of chromatic color ink;

FIG. 5 is a diagram illustrating an example of combinations of a recording medium type, a recording medium temperature, and a reaction liquid ejection amount table in the first embodiment;

FIG. 6A is a sectional view for describing a state of a reaction liquid after landing on a recording medium;

FIG. 6B is a sectional view for describing a state of a reaction liquid after landing on a recording medium;

FIG. 7A is a sectional view for describing a state of a reaction liquid after landing on a recording medium in a case where the first embodiment has been applied;

FIG. 7B is a sectional view for describing a state of a reaction liquid after landing on a recording medium in a case where the first embodiment has been applied;

FIG. 8 is a flowchart for describing image processing in a second embodiment;

FIG. 9 is a flowchart for describing processing during recording in the second embodiment;

FIG. 10A is a diagram illustrating an example of drive pulse tables for recording heads in the second embodiment; and

FIG. 10B is a diagram illustrating an example of drive pulses for a recording head in the second embodiment.

### DESCRIPTION OF THE EMBODIMENTS

The amount of a reaction liquid on a recording medium surface varies depending on the type of recording medium as well as environmental conditions during recording, such as the temperature of the recording medium, the moisture content of the recording medium, and the temperature and humidity inside the recording apparatus. For example, in the case of a recording medium which is easily permeable to liquids, after the reaction liquid lands on the recording medium, the amount of reaction liquid remaining on the recording medium surface decreases over time due to permeation of the reaction liquid into the recording medium and evaporation of the reaction liquid. For this reason, when a reaction liquid of an amount that is decided according to the type of ink is ejected, in some cases the amount of reaction liquid may be excessive or insufficient depending on the environmental conditions during recording.

Therefore, in consideration of the problem described above, an object of the present disclosure is to adjust an application amount of a reaction liquid based on a recording environment condition so that the amount of the reaction liquid that reacts with ink on a recording medium is an appropriate amount, to thereby suppress the occurrence of image unevenness and stably perform high-quality recording.

First, the present invention is described with respect to a preferred recording apparatus and system configuration with reference to the drawings. Note that, constituent elements described in the following embodiments are merely examples, and the configuration and various conditions of an apparatus to which the present invention is applied can be modified or changed as appropriate without departing from the gist of the present invention, and are not limited to those of the following embodiments.

### Recording apparatus

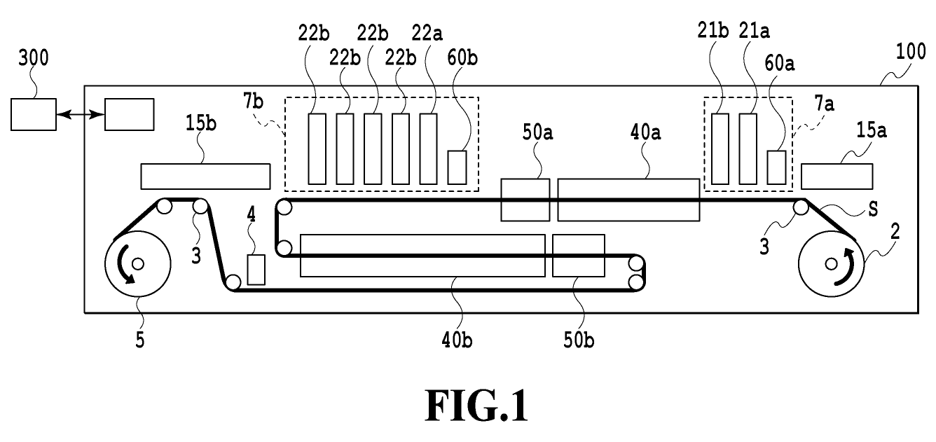

FIG. 1 is a schematic sectional view illustrating an internal configuration of a recording apparatus 100. The recording apparatus 100 of the present example is a high-speed line printer which uses a continuous recording medium wound in a roll shape as a recording medium S.

The recording apparatus 100 of the present embodiment includes various units, namely, the respective units of an unwinding roll unit 2, a main conveying roller 3, recording units 7, a scanner unit 4, a winding roll unit 5, a maintenance unit 15, drying units 40, and cooling units 50. The recording medium S is conveyed along a recording medium conveyance path indicated by a solid line in FIG. 1, and subjected to processing at each unit.

A recording process performed by the recording apparatus 100 is roughly divided into a first recording process and a second recording process. In the first recording process, an image is recorded on and fixed to the recording medium S through processing performed by a first recording unit 7a, a first drying unit 40a, and a first cooling unit 50a. In the second recording process, by processing performed by a second recording unit 7b, a second drying unit 40b, and a second cooling unit 50b, an image is recorded on and fixed to the recording medium S that underwent the first recording process. In this way, by performing the processing of the first recording process and the second recording process consecutively on the recording medium S, it is possible for the recording apparatus 100 to record an image using a reaction liquid and ink on the recording medium S. Further, it is also possible for the recording apparatus 100 to select and perform only either one of the first recording process and the second recording process according to the recording conditions. Note that, on the recording medium conveyance path and in the conveying process, although not shown in FIG. 1, control for maintaining the tension of the recording medium S at a constant tension, control for correcting an inclination during conveying, and control for maintaining the transfer speed at a constant speed and the like are performed.

The unwinding roll unit 2 is a unit for holding and applying the recording medium S that is wound into the shape of a roll. The unwinding roll unit 2 is configured to accommodate an unwinding roll, and draw out and apply the recording medium S. Note that, the number of rolls that can be accommodated is not limited to one, and the unwinding roll unit 2 may be configured to accommodate two or three or more rolls and draw out and apply the recording medium S alternately from the rolls. Further, the unwinding roll unit 2 is subjected to rotational control so as to be independently rotated forward and backward by a driving motor (not shown).

The recording unit 7 is a recording medium processing unit that performs recording by applying a liquid composition (ink) onto the recording medium S by means of recording heads 21 and 22 from above the recording medium S that is conveyed. The recording heads 21 and 22 are a plurality of recording heads arranged side by side in the conveyance direction. Further, a measurement unit 60 is provided in the recording unit 7, and the measurement unit 60 is equipped with sensors that measure the environmental temperature and environmental humidity that are the temperature and humidity within and around the recording apparatus 100, and the temperature and moisture content of the recording medium S. Although any type of sensor may be used as long as these desired measurements can be performed, a non-contact type sensor such as an infrared sensor is preferred as a sensor for measuring the temperature or moisture content of the recording medium S. The details of the measurement unit 60 will be described later.

In the present embodiment, recording heads employing an inkjet method are applied as the recording heads 21 and 22, and more specifically a method using heating elements, a method using piezoelectric elements, a method using electrostatic elements, a method using MEMS elements or the like is used. The first recording unit 7a has a measurement unit 60a, a recording head 21a corresponding to a reaction liquid that contains a component that causes an increase in the viscosity of an ink, and a recording head 21b corresponding to white ink (W ink). Further, the second recording unit 7b has a measurement unit 60b, a recording head 22a corresponding to a reaction liquid, and recording heads 22b corresponding to chromatic color (K (black), Y (yellow), M (magenta), and C (cyan)) inks. The reaction liquids and inks are fed to the recording heads 21 and 22 via respective ink tubes from unshown ink tanks. Note that, the types of colors and the number of colors and the number of recording heads 21 and 22 are not limited.

As mentioned above, the reaction liquid is a liquid containing a component that causes an increase in the viscosity of an ink. Here, the phrase "an increase in the viscosity of an ink" refers to a state in which a color material, a resin, or the like constituting the ink comes into contact with the component that causes an increase in the viscosity of the ink, and thereby chemically reacts with or is physically adsorbed to the component, resulting in the occurrence of an increase in the viscosity of the ink. An increase in the viscosity of an ink is not limited to an increase in the overall viscosity of an ink, and also includes a case where a local increase in viscosity occurs due to partial aggregation of a component constituting the ink, such as a color material or a resin. The component that causes an increase in the ink viscosity may be a component such as metal ions or a polymer aggregating agent or the like, and is not particularly limited, and a substance that induces a pH change in ink and causes a color material in the ink to aggregate can be used, or an organic acid can be used. If the reaction liquid is applied to the recording medium S before applying an ink thereto, the ink that reaches the recording medium S can be immediately fixed thereto. This makes it possible to suppress bleeding, which is the mixing together of adjacent inks. Note that, although in the present example ink is applied to the recording medium S using inkjet recording heads, a method for applying ink onto the recording medium using the recording unit 7 is not particularly limited to this method. For example, although in the present example the reaction liquid is applied by means of the recording head 21, a configuration may be adopted in which the reaction liquid is applied by a roller, a die coating apparatus, a blade coating apparatus, or the like.

The drying units 40 (first drying unit 40a and second drying unit 40b) are units that reduce the liquid content contained in the liquid composition applied to the recording medium S in the recording unit 7, and thereby enhance a fixing property between the recording medium S and the ink. The drying units 40 blow high-temperature air onto the recorded recording medium S, to thereby dry the applied ink. When the recording medium S passes through the inside of the drying units 40, air is blown onto the recording medium S from at least the side of the face on which ink has been applied, to thereby dry the face on which ink has been applied of the recording medium S. The temperature of the air blown by the drying units 40 toward the recording medium S is controlled by a heater unit or the like mounted inside the drying units 40. Note that, a configuration may also be adopted in which the drying method, apart from adopting a method that blows air, is combined with a method that irradiates electromagnetic waves (ultraviolet rays, infrared rays, or the like) onto the surface of the recording medium S or a conductive heat transfer method that uses contact with a heating device.

The cooling units 50 (first cooling unit 50a and second cooling unit 50b) cool the recording medium S on which the ink was fixed in the drying units 40 to thereby solidify the softened ink, and also suppress the amount of change in the temperature of the recording medium S in downstream processes in the recording apparatus 100. When the recording medium S passes through the inside of the cooling units 50, air that is at a lower temperature than the temperature of the recording medium S is blown onto the recording medium S from at least the side of the face onto which ink has been applied of the recording medium S, to thereby cool the face onto which ink has been applied of the recording medium S. Note that, the cooling method is not limited to a method that blows air, and a conductive heat transfer method that uses contact with a heat-dissipating member may be adopted, or a configuration that combines these methods may be adopted.

Note that, even in a case where recording is not performed by the recording unit 7a, as a pre-treatment for recording in the recording unit 7b, the first drying unit 40a and the first cooling unit 50a can also be used to heat the recording medium S by blowing air or cool the recording medium S by blowing air before applying a liquid composition onto the recording medium S.

The scanner unit 4 is a unit utilized to read a test image formed on the recording medium S by the recording unit 7 before the main recording, and detect image deviations and density and make corrections for the main recording.

The winding roll unit 5 is a unit for winding the recording medium S that has undergone the recording processing around a winding core. The number of rolls that can be collected is not limited to one, and a configuration may be adopted in which the winding roll unit 5 has two or three or more winding cores and alternately switches between the winding cores to collect the recording medium S.

The maintenance unit 15 is a unit that includes a mechanism for restoring the discharge performance of the recording heads 21 and 22. Examples of such a mechanism include a cap mechanism for protecting the ink discharge surface of the recording heads 21 and 22, a wiper mechanism for wiping the ink discharge surface, and a suction mechanism for suctioning ink inside the recording head 21 and 22 from the ink discharge surface with negative pressure. The maintenance unit also includes an unshown drive mechanism and rails, and is capable of reciprocally moving horizontally along the rails. When performing maintenance of a recording head, the maintenance unit moves to a position directly below the recording head, and when a maintenance operation is not being performed, the maintenance unit moves to a position that is away from a position directly below the recording head. In the present example, a first maintenance unit 15a and a second maintenance unit 15b are provided to correspond with the first recording unit 7a and the second recording unit 7b, respectively.

### System configuration

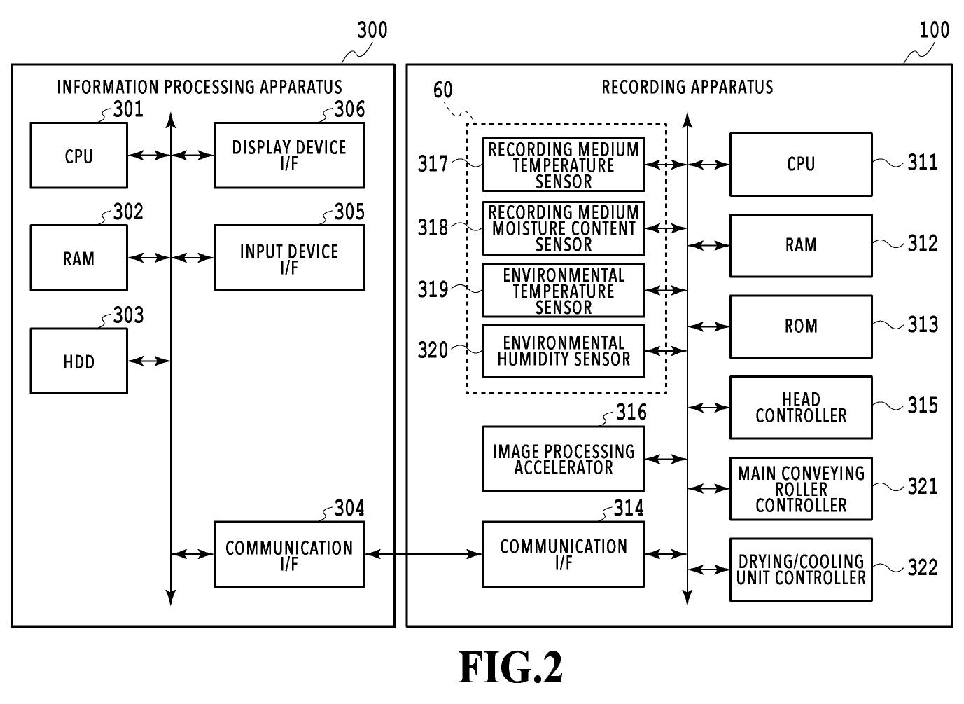

FIG. 2 is a block diagram illustrating an example of the overall configuration of a system that includes the recording apparatus 100 according to the present embodiment. As illustrated in FIG. 2, the system according to the present embodiment is constituted by the recording apparatus 100 illustrated in FIG. 1, and an information processing apparatus (a PC) 300 as a host apparatus for the recording apparatus 100.

The information processing apparatus 300 includes a CPU 301, a RAM 302, a HDD (Hard Disk Drive) 303, a communication I/F 304, an input device I/F 305, and a display device I/F 306. The respective functional units that the information processing apparatus 300 has are communicably connected with each other by an internal bus. The CPU 301 executes processing in accordance with programs and various kinds of data held in the HDD 303 or the RAM 302. The RAM 302 is a volatile storage, and temporarily holds programs and data. The HDD 303 is a nonvolatile storage, and stores programs and data.

The communication I/F 304 is an interface that controls communication with external apparatuses, and in this example the communication I/F 304 controls data transmission and reception with the recording apparatus 100. Here, a wired connection such as a USB connection, an IEEE 1394 connection, or a local area network (LAN) connection, or a wireless connection such as a Bluetooth (registered trademark) connection or a WiFi (registered trademark) connection can be used as a connection method for the data transmission and reception. The input device I/F 305 is an interface for controlling a HID (human interface device), such as a keyboard or a mouse, and receives inputs from a user via an input device. The display device I/F 306 controls the display on a display device such as a display (not shown).

Here, although the following description is based on the assumption that the information processing apparatus 300 is a separate apparatus from the recording apparatus 100, the implementation mode for these apparatuses is not particularly limited as long as the same processing can be performed. For example, the information processing apparatus 300 may be an apparatus that is built into the recording apparatus 100, or may be a server connected to the recording apparatus 100 via a network. Furthermore, for example, the information processing apparatus 300 may be a portable terminal such as a smartphone, a tablet terminal, or an image capturing apparatus.

The recording apparatus 100 includes a CPU 311, a RAM 312, a ROM 313, a communication I/F 35, a head controller 315, and an image processing accelerator 316. In addition, the respective functional units that the recording apparatus 100 has are communicably connected with each other by an internal bus. The CPU 311 executes processing relating to each embodiment described later in accordance with programs and various kinds of data held in the ROM 313 or the RAM 312. The RAM 312 is a volatile storage, and temporarily holds programs and data. The ROM 313 is a nonvolatile storage, and stores various data such as table data and programs used in processing that is described later.

The communication I/F 35 is an interface that controls communication with external apparatuses, and in this example the communication I/F 314 controls data transmission and reception with the information processing apparatus 300. The head controller 315 performs control of the recording heads 21 and 22 illustrated in FIG. 1 based on image formation data. Specifically, the head controller 315 can be configured to read control parameters and image formation data from predetermined addresses in the RAM 312.

When the CPU 311 writes the control parameters and the image formation data to predetermined addresses of the RAM 312, recording processing is started by the head controller 315, and ink ejection operations are performed by the recording heads 21 and 22. The image processing accelerator 316 is constituted by hardware, and can execute image processing faster than the CPU 311. Specifically, the image processing accelerator 316 may be configured to read parameters and data required for the image processing from predetermined addresses of the RAM 312. Here, when the CPU 311 writes parameters and data required for the image processing to predetermined addresses of the RAM 312, the image processing accelerator 316 is activated and predetermined image processing is performed. Note that, the image processing accelerator 316 is not necessarily an essential element, and depending on the specifications and the like of the recording apparatus 100, image processing may be executed only by the processing of the CPU 311.

### First Embodiment

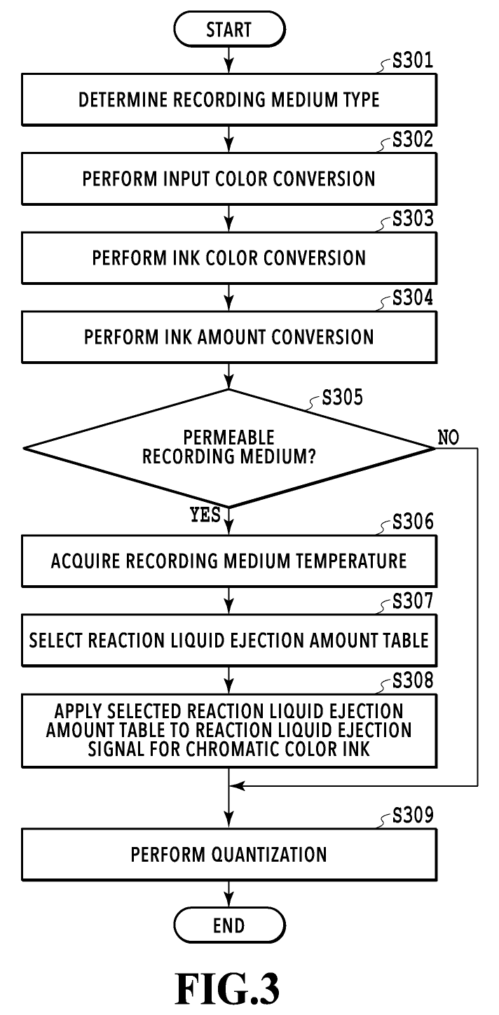

Hereunder, a recording method according to a first embodiment is described using FIGS. 3-7.

When performing recording, in addition to the image data to be recorded, recording medium information is input and is transmitted to the recording apparatus 100, and image processing that is described hereunder is performed. Note that, information indicating the type of recording medium is included in the recording medium information.

A flowchart for describing image processing that the recording apparatus 100 according to the first embodiment performs is shown in FIG. 3.

In S301, the recording apparatus 100 determines the type of recording medium S that was input, and processing corresponding to the type of recording medium S that is determined is performed in the following S302, S303, and S304.

In S302, the recording apparatus 100 converts input image data received from the information processing apparatus 300 to image data corresponding to the color gamut of the recording apparatus 100. In the present embodiment, it is assumed that the input image data is data indicating color coordinates (R, G, B) in a color space coordinate system such as sRGB that are colors for representation of a monitor, and the value of each color component is expressed in 8 bits. The recording apparatus 100 according to the present embodiment converts the RGB input image data into image data (R', G', B') corresponding to the color gamut of the recording apparatus 100 by a known method such as matrix computation processing or processing using a three-dimensional lookup table (3D LUT). In the present embodiment, a 3D LUT is used, and conversion processing is performed by combining use of the 3D LUT with interpolation calculations. Further, the format of the input image data is not limited to the aforementioned format, and for example, input image data in the CMYK format can also be used, and in such case conversion of the input image data can be performed by processing using a four-dimensional LUT or the like.

In S303, the recording apparatus 100 converts the RGB image data processed in S302 into image data corresponding to color signal data for white ink and the chromatic color inks used in the recording apparatus 100. In the present embodiment, because inks for the colors W, K, C, M, and Y are used, the image data of the RGB signals is converted into image data composed of 8-bit color signals for each of the colors W, K, C, M, and Y. Similarly to the processing in S302, it is possible to perform the color conversion processing in S303 by using interpolation calculations in combination with the 3D LUT. Note that, as another conversion method, similarly to S302, a method such as matrix computation processing may be used. Further, although the five colors of W, K, C, M, and Y are mentioned as an example of the number of inks, other inks may be additionally included, and some of the aforementioned inks do not have to be used.

In S304, the recording apparatus 100 converts the image data consisting of data for WCMYK color signals into ink ejection signals that have been corrected so as to correspond to the number of dots used during recording. An arbitrary method can be adopted as the method for converting into ink ejection signals, such as a method that performs gamma adjustment using a one-dimensional LUT. Here, it is assumed that the ink ejection signal is information indicating the ejection amount of the ink during recording.

In S305, the recording apparatus 100 determines whether or not the recording medium S is a recording medium that has permeability to liquids, and determines whether or not to modulate the ejection amount of the reaction liquid according to a recording environment condition (temperature or moisture content of the recording medium, or temperature or humidity inside or around the recording apparatus). If the recording medium is permeable, the process proceeds to S306, while if the recording medium is a non-permeable recording medium (has low permeability), the process proceeds to S309. In a case where the recording medium is non-permeable, since the reaction liquid does not permeate into the recording medium, there is no necessity to change the ejection amount of the reaction liquid according to a recording environment measurement value, and therefore a single reaction liquid ejection amount table is applied. Therefore, the flow of processing in S306 and S307 is not performed. Note that, the term "non-permeable" refers to a state in which the amount of reaction liquid that permeates the recording medium is less than a predetermined amount.

Note that as an example of a method for evaluating the permeability of the recording medium, Bristow's method described in "Method for determining the liquid absorbability of paper and board" in JAPAN TAPPI Paper Pulp Test Method No. 51 can be used. Hereunder, the measurement method using Bristow's method is briefly described.

First, a predetermined amount of ink is injected into a holding container having an opening slit of a predetermined size, and through the slit, the ink is brought into contact with a recording medium that has been processed to have a strip shape and wound around a disk. Next, the disk is rotated while keeping the holding container fixed in position, and the area (length) of an ink band transferred to the recording medium is measured. The transfer amount (ml/m⁻²) per second per unit area can be calculated based on the area of the ink band. In the present embodiment, a recording medium for which the transfer amount (absorption amount) of ink at 30 msec^{1/2} measured using Bristow's method is less than 10 ml/m⁻² is regarded as a recording medium that has low permeability (a non-permeable recording medium).

In S306, the recording apparatus 100 acquires a measurement result with respect to a recording environment condition from the measurement units 60a and 60b. Here, an example is described in which the temperature of the recording medium S measured by a recording medium temperature sensor 317 included in the measurement units 60a and 60b is acquired.

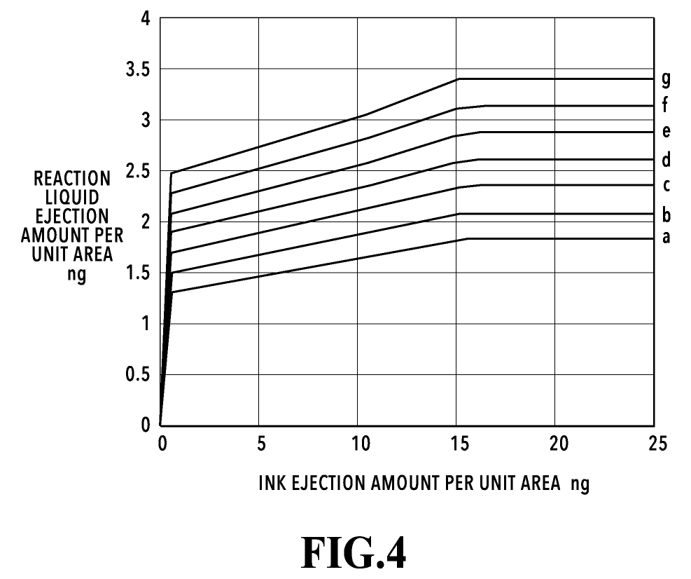

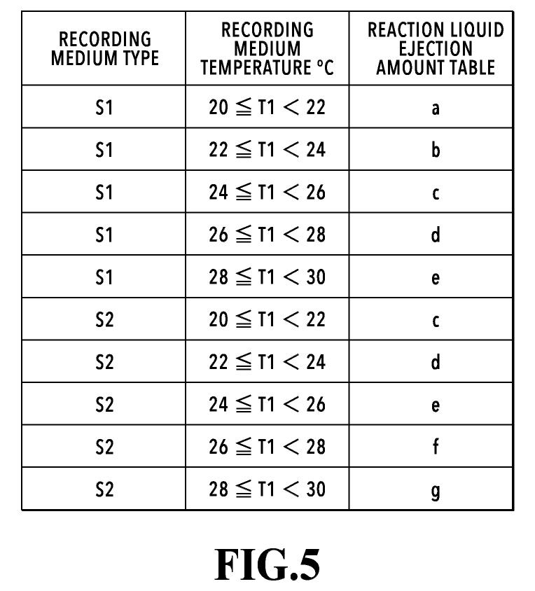

In S307, the recording apparatus 100 selects a reaction liquid ejection amount table that corresponds to the combination of the type of the recording medium S and the temperature of the recording medium S acquired in S306. A reaction liquid ejection amount table defines a reaction liquid ejection signal that indicates the ejection amount of reaction liquid based on the ink ejection signal for each color component of the ink processed in S304, and is stored in the ROM 313. A plurality of reaction liquid ejection amount tables is stored in the ROM 313 so that the application amount of reaction liquid can be changed according to the combination of the type of recording medium S and the temperature of the recording medium S. FIG. 4 shows an example of reaction liquid ejection amount tables. Further, FIG. 5 shows an example of combinations of recording medium temperatures and reaction liquid ejection amount tables for each type of recording medium S. Note that, although an example of reaction liquid ejection amount tables that can be shared by recording media S1 and S2 is shown in FIG. 4, reaction liquid ejection amount tables that differ for each recording medium may also be prepared. In addition, reaction liquid ejection amount tables that are different for a reaction liquid for W ink and a reaction liquid for chromatic color ink may be applied. Furthermore, in FIG. 5 an example is illustrated in which reaction liquid ejection amount tables are selected by setting 20°C to 30°C as the temperature range of the recording medium S, and dividing that temperature range into segments in increments of 2°C. However, the configuration of the reaction liquid ejection amount tables is not limited to this example, and the temperature range and the width of each temperature segment are not limited to this example and may be set arbitrarily, and the temperature range and the width of each temperature segment may be changed for each type of recording medium S. By this means, the reaction liquid ejection amount can be modulated relative to the ink ejection amount depending on the type and temperature of the recording medium S.

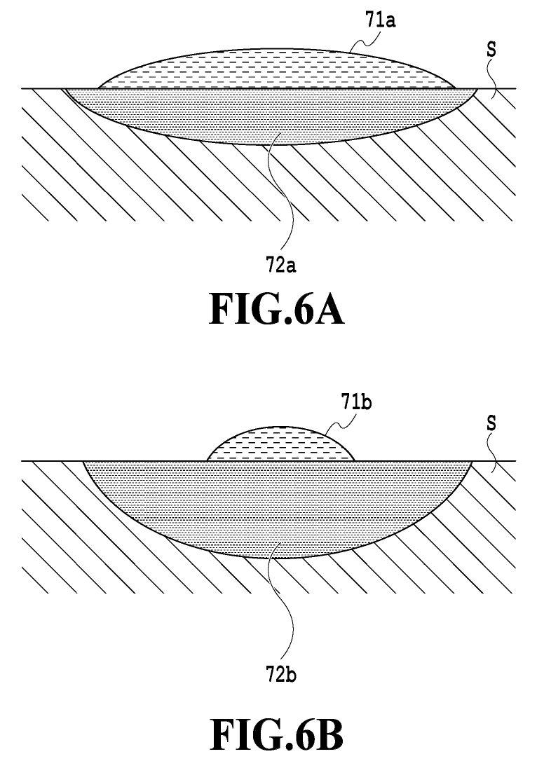

Here, FIGS. 6A and 6B are views that illustrate the manner in which the state of a reaction liquid applied to the recording medium S changes. Because the reaction liquid applied to the recording medium S permeates into the interior of the recording medium S over time, the reaction liquid separates into a residual reaction liquid 71 that remains on the surface of the recording medium S, and a permeated reaction liquid 72 that has permeated into the interior of the recording medium S. The amount of a residual reaction liquid 71a illustrated in FIG. 6A is taken as representing an appropriate amount for ink aggregation, and the state at such time is taken as the result obtained by ejecting the reaction liquid in a case where a reaction liquid ejection amount table d was applied.

In contrast, in a case where the recording medium S is a recording medium of a type that has higher permeability, or in a case where even though the recording medium S is of the same type, the temperature of the recording medium S is high, the permeation speed increases due to a decrease or the like in the viscosity or surface tension the reaction liquid that landed on the recording medium S. The example illustrated in FIG. 6B is an example in which a reaction liquid of the same amount as in the example illustrated in FIG. 6A has been applied to the recording medium S that has higher permeability than the recording medium S illustrated in FIG. 6A. In the example illustrated in FIG. 6B, a residual reaction liquid 71b decreases and a permeated reaction liquid 72b increases in comparison to the example illustrated in FIG. 6A. Therefore, there is a possibility that the amount of the residual reaction liquid 71b illustrated in FIG. 6B will be insufficient as an amount that is suitable for ink aggregation, resulting in a decrease in the quality of the formed image.

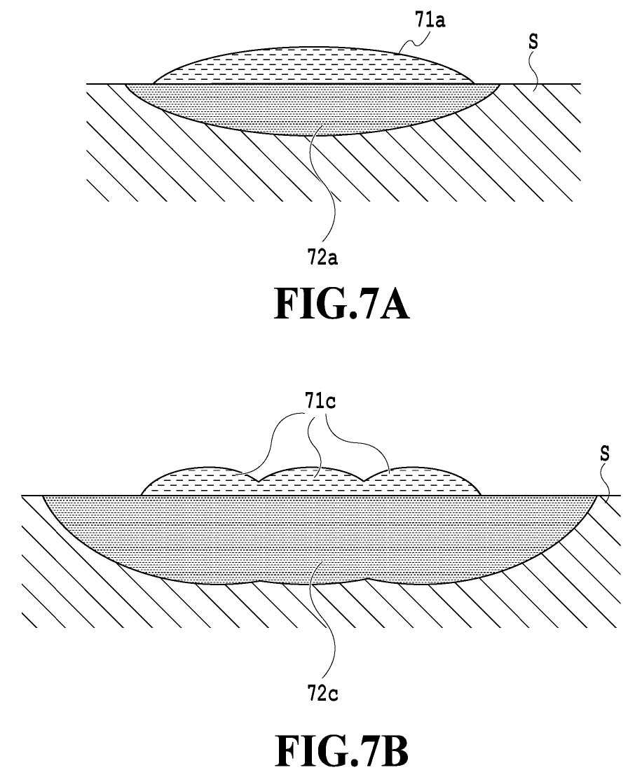

In the present embodiment, in a case where the permeability of the recording medium S has become high in this manner, the reaction liquid ejection amount table is changed to a reaction liquid ejection amount table with which the amount of the residual reaction liquid 71 remaining on the surface of the recording medium S becomes approximately the same as the amount of the residual reaction liquid 71a described above. In an example illustrated in FIG. 7B, the reaction liquid ejection amount table has been changed to a reaction liquid ejection amount table g with which the ejection count per unit area increases by a multiple of three relative to the reaction liquid ejection amount table d. Thus, in the present embodiment, regardless of the type of recording medium S or the recording medium temperature, the aggregation state with ink can be kept constant, and stable images can be obtained.

In S308, the recording apparatus 100 applies the reaction liquid ejection amount table selected in S307 to the reaction liquid ejection signal for the reaction liquid for chromatic color ink.

In S309, the recording apparatus 100 performs quantization processing on the reaction liquid ejection signal and W, K, C, M, and Y that are the ink ejection signals, and then ends the image processing. There are various quantization levels available for the quantization processing, such as binary quantization, or ternary quantization to quantization to 16 levels. In general, during binarization processing, the reaction liquid ejection signal and the ink ejection signals W, K, C, M, and Y are each converted into one-bit data indicating whether or not there is an ink dot for each of the reaction liquid, W, K, C, M, and Y, and the ejection count per unit area is determined according to the ejection amount. A known pseudo-halftone processing method such as a dither matrix method or an error diffusion method may be used as the quantization processing method.

When the image processing is completed and recording is started, the CPU 311 controls a main conveying roller controller 321 to drive the main conveying roller 3 to perform conveying of the recording medium S, and in addition, the head controller 315 drives the recording heads 21 and 22 to perform recording on the recording medium S.

Although in the foregoing description an example in which a measured temperature value of the recording medium S is fed back is described, another value may be used, and furthermore, a plurality of measured values such as the temperature and moisture content of the recording medium S may be used. By this means, since a more detailed reaction liquid ejection amount table can be prepared, the reaction liquid ejection amount can be controlled more precisely in response to a change in the recording environment conditions.

Further, other methods that may be adopted include a method in which recording operations are performed after estimating the temperature and moisture content of the recording medium S based on the temperature and humidity inside and around the recording apparatus 100, and a method in which a measurement unit 60 is also provided outside and inside the recording apparatus 100 apart from the recording unit 7 and the average value of values obtained by a plurality of sensors is applied or a worst value among the obtained values is applied.

Note that, although an example in which recording medium information is input when performing recording is described above, it is also conceivable that a case may arise where the type of recording medium S designated by the input recording medium information is not registered in the recording apparatus 100. In such a case, it suffices to take a measure such as having the user select a similar type of recording medium, or having the user input only information indicating whether the recording medium S is a permeable recording medium or a non-permeable recording medium, or having the user select whether or not to perform recording in a mode that modulates the reaction liquid amount. Further, a configuration may also be adopted that allows a user to add or modify a reaction liquid ejection amount table.

As described above, by applying the recording method of the present invention, variations in the amount of reaction liquid remaining on the surface of a recording medium S when ink lands on the recording medium S can be reduced regardless of the type of recording medium S and the recording environment conditions, and thus high-quality images can be consistently recorded.

### Second embodiment

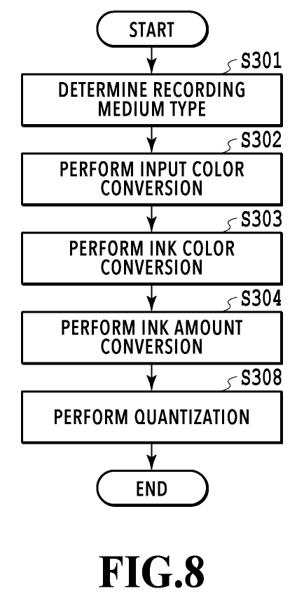

A recording method according to a second embodiment will now be described using FIGS. 8 -10. Although in the first embodiment the reaction liquid ejection signal is modulated in accordance with a recording environment condition, in the second embodiment the reaction liquid ejection signal is not modulated, and instead drive pulses which are input to the recording heads 21a and 22a are modulated in accordance with a recording environment condition to thereby adjust the ejection amount per ejection operation.

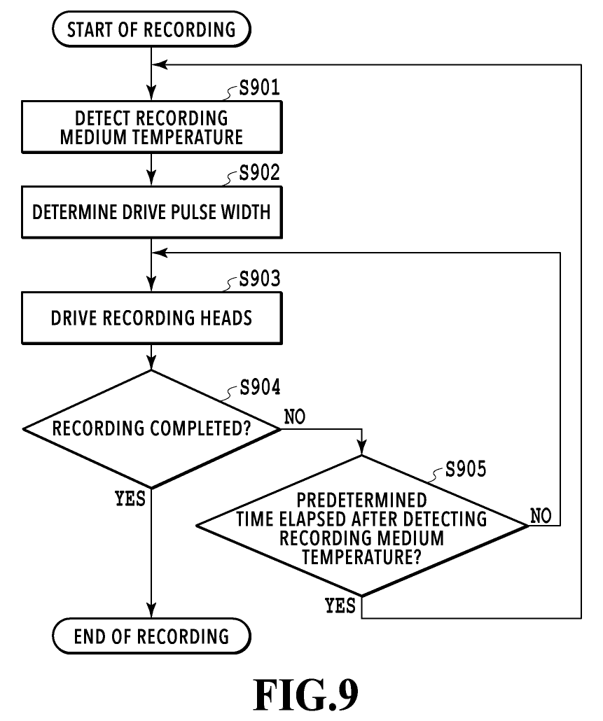

A flowchart for describing image processing that the recording apparatus 100 according to the second embodiment performs is shown in FIG. 8. Although in the second embodiment also, similarly to the first embodiment, recording medium information is input together with the image data to be recorded, at the image processing stage the same processing is performed regardless of whether the recording medium S is a permeable recording medium or a non-permeable recording medium. In other words, S301 to S304 and S308 in FIG. 3 are performed in that order. If it is determined in S301 that the recording medium S is a permeable recording medium, after the processing up to S308 is completed, when recording is started, the recording is performed according to the flow of processing shown in FIG. 9. If it is determined in S301 that the recording medium S is a non-permeable recording medium, recording is performed without performing modulation of drive pulses that are input to the recording heads described later.

In S901, the recording apparatus 100 acquires information relating to a recording environment measurement value from the measurement units 60a and 60b. Here, similarly to the first embodiment, an example in which the recording apparatus 100 acquires a value measured by the recording medium temperature sensor 317 is described.

In S902, based on the type of the recording medium S and the temperature of the recording medium S, the recording apparatus 100 selects drive pulse to be input to the recording heads 21a and 22a that eject a reaction liquid, in accordance with a drive pulse table that has been prepared in advance.

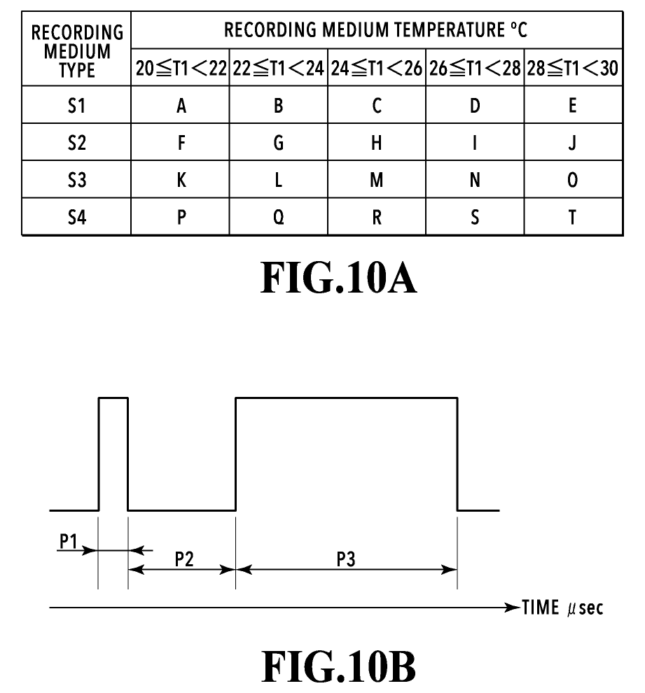

The drive pulse table is stored in the ROM 313, and an example of the drive pulse table is illustrated in FIGS. 10A and 10B. As illustrated in FIG. 10A, drive pulse information A to T which is to be input according to the combination of the recording medium type and the temperature of the recording medium is stored. Specifically, each item of drive pulse information includes values corresponding to a preheat pulse P1, an interval P2, and a main heat pulse P3 that are illustrated in FIG. 10B. Further, the values for P1 to P3 are set such that, when the recording medium type is the same, the lower the temperature of the recording medium S is, the smaller the ejection amount of the reaction liquid is, and the higher the temperature of the recording medium S is, the larger the ejection amount of the reaction liquid is. In addition, the values for P1 to P3 are set such that the higher the permeability of the recording medium S is, the larger the ejection amount is, and the lower the permeability of the recording medium S is, the smaller the ejection amount is.

In S903, the recording apparatus 100 transmits the drive pulse information selected in S902 to the head controller 315 to drive the recording heads 21 and 22 and perform recording.

In S904, the recording apparatus 100 determines whether or not recording has been completed, and if recording has not been completed, in S905 the recording apparatus 100 determines whether or not a predetermined time has elapsed since the recording medium temperature was measured. The predetermined time may be set arbitrarily, and it suffices to set the predetermined time within the range of about one to several minutes. If the predetermined time has not elapsed, the process returns to S903 to continue recording operations.

In S905, the recording apparatus 100 determines whether or not a predetermined time has elapsed since the recording medium temperature was acquired in S901. If the predetermined time has elapsed, the process returns to S901 to acquire the recording medium temperature again, and the flow of processing from S902 onwards is performed again. For example, in a case where the temperature of the recording medium S has risen significantly compared to the time when the temperature was previously acquired, in S902 a new drive pulse is selected and sent to the recording head 22a.

The cycle of processing in steps S901 to S905 continues until it is determined in S904 that recording has been completed.

Note that, a technique for modulating a drive pulse in accordance with the temperature of a recording head during a recording operation is known, and in the present embodiment also the drive pulse table shown in FIG. 10 may be made even more detailed by also taking into account the temperature of the recording head 22a.

Further, although in the present embodiment the temperature of the recording medium S is fed back as a recording environment measurement value, the recording environment measurement value may also be the moisture content of the recording medium S, the environmental temperature, or the environmental humidity, or a combination of a plurality of measurement values, such as the temperature and moisture content of the recording medium S, may be used.

The present embodiment described above is particularly effective when recording continuously for a long time period or the like. As mentioned above in the description of FIG. 1, the recording medium S is subjected to a drying process after recording, and in some cases the heat generated by operating the drying units 40 may cause the temperature and humidity inside or around the recording apparatus 100 as well as the temperature and moisture content of the recording medium S to change after recording starts. Even under such circumstances, because the reaction liquid remaining on the surface of the recording medium S when the ink is applied can be maintained at an appropriate amount by modulating the amount of reaction liquid that is ejected, it is possible to perform stable recording.

Note that, although a configuration that includes the measurement units 60a and 60b is adopted in the above embodiments, a configuration that includes only either one of these measurement units may be adopted. However, in a case where a measurement unit is installed in only either one of the first recording unit 7a and the second recording unit 7b and the temperature of the recording medium S is used as the recording environment measurement value, only modulation of the reaction liquid ejection signal or a recording head drive pulse that is used in the recording unit in which the measurement unit is installed is performed. For example, in a case where only the measurement unit 60b that the second recording unit 7b includes is installed, and the temperature of the recording medium S is utilized as the recording environment measurement value, only a reaction liquid ejection signal for chromatic color ink or a drive pulse to be input to the recording head 22a is modulated according the recording environment condition.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure it is possible to adjust the application amount of a reaction liquid based on a recording environment condition so that the amount of reaction liquid that reacts with ink on a recording medium is an appropriate amount, to thereby suppress the occurrence of image unevenness and stably perform high-quality recording.

This application claims the benefit of Japanese Patent Application No. 2025-076892, filed May 2, 2025, which is hereby incorporated by reference herein in its entirety.

What is claimed is:

1. A recording apparatus, comprising:
a recording unit configured to apply ink and a reaction liquid that reacts with the ink onto a recording medium to record an image,
a measurement unit configured to measure a recording environment condition during recording by the recording unit, and
a control unit configured to control an application amount of the reaction liquid from the recording unit based on a measurement result obtained by the measurement unit.

2. The recording apparatus according to claim 1, wherein:
the recording environment condition includes at least one of a temperature of the recording medium, a moisture content of the recording medium, an environmental temperature inside or around the recording apparatus, and an environmental humidity inside or around the recording apparatus.

3. The recording apparatus according to claim 1, further comprising:
an acquiring unit for acquiring information indicating a type of the recording medium;
wherein:
the control unit controls the application amount of the reaction liquid according to the measurement result and the type of the recording medium.

4. The recording apparatus according to claim 1, wherein:
if the recording medium is non-permeable to the reaction liquid, the control unit does not perform control based on the measurement result obtained by the measurement unit.

5. The recording apparatus according to claim 1, wherein:
the control unit controls the application amount of the reaction liquid relative to an application amount of the ink per unit area for each predetermined temperature segment.

6. The recording apparatus according to claim 1, wherein:
the control unit controls the application amount of the reaction liquid by controlling an ejection count of the reaction liquid per unit area from the recording unit.

7. The recording apparatus according to claim 1, wherein:
the control unit controls the application amount of the reaction liquid by controlling an ejection amount per ejection operation of the reaction liquid from the recording unit.

8. The recording apparatus according to claim 1, wherein:
the control unit controls so that an amount of the reaction liquid remaining on a surface of the recording medium when the ink is applied by the recording unit is a suitable amount for aggregating the ink.

9. A recording method, comprising:
a step of recording an image by applying ink and a reaction liquid that reacts with the ink onto a recording medium,
a step of measuring a recording environment condition in the step of recording, and
a step of controlling an application amount of the reaction liquid in the step of recording based on a measurement result obtained by the step of measuring.

10. A non-transitory computer readable storage medium storing a program for causing a computer to perform an information processing method comprising:
a step of recording an image by applying ink and a reaction liquid that reacts with the ink onto a recording medium,
a step of measuring a recording environment condition in the step of recording, and
a step of controlling an application amount of the reaction liquid in the step of recording based on a measurement result obtained by the step of measuring.
